(19) United States
(12) Patent Application Publication
(10) Pub. No.: US 2010/0073305 A1
(43) Pub. Date: Mar. 25, 2010

(54) Techniques for Adjusting a Size of Graphical Information Displayed on a Touchscreen

(76) Inventors: Jennifer Greenwood Zawacki, Hillsborough, NC (US); Just Tyler Dubs, Durham, NC (US)

Correspondence Address: DILLON & YUDELL LLP, 8911 N. CAPITAL OF TEXAS HWY, SUITE 2110, AUSTIN, TX, 78759, US

(21) Appl. No.: 12/238,163

(22) Filed: Sep. 25, 2008

(51) Int. Cl. G06F 3/041

(52) U.S. Cl. 345/173

(57) ABSTRACT

A technique for adjusting graphical information displayed on a touchscreen of a device includes detecting a first input to the touchscreen. Which one of multiple instruments was utilized to provide the first input is then determined. The graphical information displayed on the touchscreen is then sized based on which one of the multiple instruments was utilized to provide the first input.

### BACKGROUND

1. Field

This disclosure relates generally to a touchscreen and, more specifically to techniques for adjusting a size of graphical information displayed on a touchscreen based on an instrument that provides input to the touchscreen.

2. Related Art

A touchscreen is a display that is configured to detect a presence and location of a touch (or near touch) input to an area of the touchscreen. Many touchscreens are configured to sense contact by an instrument, such as a stylus or a finger. Other touchscreens are configured to sense both passive objects (e.g., a finger, a pencil eraser, or a passive stylus) and active objects (e.g., an active stylus such as a digitizer pen) that may not contact the touchscreen. Touchscreens may be configured to concurrently sense a single point of contact or multiple points of contact. In general, touchscreens facilitate user interaction with what is displayed directly on the touchscreen, as contrasted with indirect interaction through, for example, a mouse or a touchpad.

Touchscreens are frequently incorporated within devices such as personal digital assistants (PDAs), satellite navigation equipment, point-of-sale systems, kiosk systems, automatic teller machines (ATMs), portable gaming consoles, mobile phones, smart phones, etc. A wide variety of different technologies may be employed in touchscreens. For example, touchscreens may implement resistive, surface acoustic wave (SAW), capacitive, infrared, strain gauge, optical imaging, or dispersive signal technologies, among other technologies, depending on an application. A tablet personal computer (PC) is an example of a mobile computer system that usually employs a touchscreen to facilitate user input (via a stylus, digital pen, fingertip, or other instrument) to operate the tablet PC. Tablet PCs are often used where normal notebook computer systems (notebooks) are impractical, unwieldy, or do not provide a needed functionality.

### SUMMARY

According to one or more embodiments of the present invention, a technique for adjusting graphical information on a touchscreen of a device includes detecting a first input to the touchscreen. Which one of multiple instruments was utilized to provide the first input is then determined. The graphical information displayed on the touchscreen is then sized based on which one of the multiple instruments was utilized to provide the first input.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is a block diagram of a relevant portion of an example device that is configured to size graphical information displayed on an associated touchscreen based on which one of multiple instruments was utilized to provide input to the touchscreen, according to one or more embodiments of the present disclosure.

FIG. 2 is a flowchart of an example process for sizing graphical information displayed on an associated touchscreen based on which of multiple instruments was utilized to provide input to the touchscreen, according to one or more embodiments of the present disclosure.

### DETAILED DESCRIPTION

As will be appreciated by one of ordinary skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product on a computer-readable storage medium having computer-readable program code embodied in the medium.

Any suitable computer-usable or computer-readable storage medium may be utilized. The computer-usable or computer-readable storage medium may be, for example, but is not limited to, an electronic, magnetic, optical, electromagnetic, infrared, or semiconductor system, apparatus, or device. More specific examples (a non-exhaustive list) of the computer-readable storage medium includes the following: a portable computer diskette, a hard disk, a random access memory (RAM), a read-only memory (ROM), an erasable programmable read-only memory (EPROM) or flash memory, a portable compact disc read-only memory (CD-ROM), an optical storage device, or a magnetic storage device. It should be noted that the computer-usable or computer-readable storage medium can even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable storage medium may be any medium that can contain or store a program for use by or in connection with an instruction execution system, apparatus, or device.

Computer program code for carrying out operations of the present invention may be written in an object oriented programming language, such as Java, Smalltalk, C++, etc. However, the computer program code for carrying out operations of the present invention may also be written in conventional procedural programming languages, such as the “C” programming language or similar programming languages. The program code may execute entirely on a single processor, on multiple processors that may be remote from each other, or as a stand-alone software package. When multiple processors are employed, one processor may be connected to another processor through a local area network (LAN) or a wide area network (WAN), or the connection may be, for example, through the Internet using an Internet service provider (ISP).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. As used herein, the term “coupled” includes both a direct electrical connection between blocks or components and an indirect electrical connection between blocks or components achieved using intervening blocks or components.

According to various aspects of the present disclosure, techniques are employed that size graphical information displayed on a touchscreen based on an instrument utilized to provide input (via the touchscreen) to an associated device. In general, a size of the graphical information is enlarged when a user is using a relatively large object (e.g., a finger) to provide input to the touchscreen and is shrunk when the user is using a relatively small object (e.g., a stylus) to provide input to the touchscreen. In general, modifying a size of graphical information provided on a touchscreen, based on a size of an instrument that is utilized to provide input to the touchscreen, increases the usability of an associated device as more accurate input is typically received.

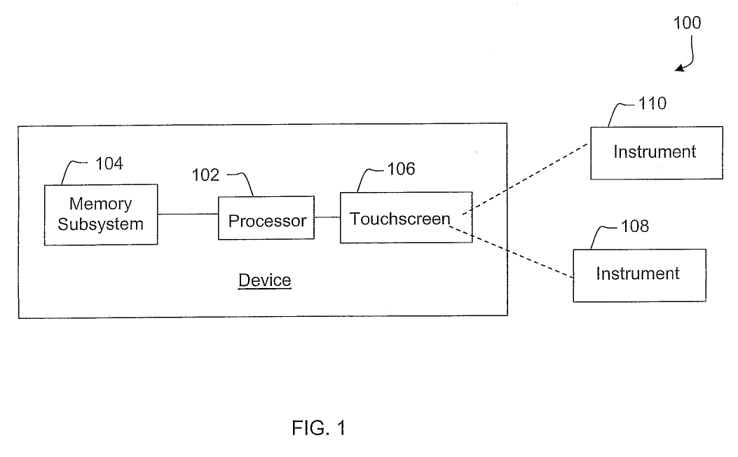

With reference to FIG. 1, an example device 100 is illustrated that includes a touchscreen 106 that is configured to receive input from a user via instruments 108 and 110. The instrument 108 may correspond to, for example, an active or passive stylus. The instrument 110 may correspond to, for example, an eraser of a pencil or a finger of a user. In devices configured to receive input from passive objects, when a passive object activates a number of pixels of a touchscreen above a predetermined level (e.g., ten pixels), displayed graphical information size is increased. Similarly, when a passive object activates a number of pixels below a predetermined level (e.g., five pixels), displayed graphical information size is decreased. It should be appreciated that more than two different sizes of graphical information may be displayed based on a size of the instrument that is providing input to a touchscreen. As is shown, the touchscreen 106 is coupled to a processor 102 (that includes one or more central processing units (CPUs)), which is coupled to a memory subsystem 108 (which includes an application appropriate amount of volatile and non-volatile memory). The device 100 may also include, for example, a video card, a hard disk drive (HDD), a network interface card (NIC), a compact disk read-only memory (CD-ROM) drive, among other components not shown in FIG. 1. The device 100 may be, for example, a tablet PC, a personal digital assistant (PDA), a smart phone, or virtually any other device that employs a touchscreen.

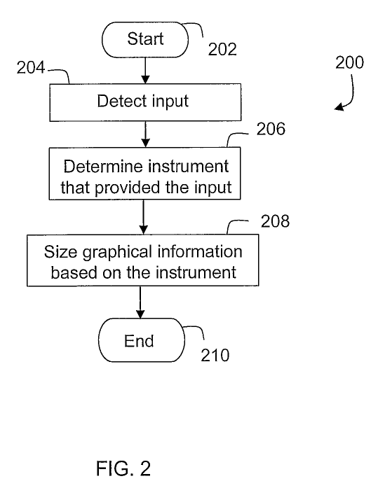

Moving to FIG. 2, an example process 200 for sizing graphical information displayed on a touchscreen (e.g., the touchscreen 106 of FIG. 1) is illustrated. In block 202, the process 200 is initiated at which point control transfers to block 204, where a processor detects an input to the touchscreen 106 of the device 100. The processor may correspond to a general purpose processor (e.g., the processor 102 of the device 100) or a graphics processor that may be located on a video card or integrated on a mother board with the processor 102. Next, in block 206, the processor determines which one of multiple instruments 108 and 110 was utilized (by a user) to provide the input to the touchscreen 106. As noted above, the multiple instruments may include passive objects, active objects, or passive and active objects. Then, in block 208, the processor facilitates sizing graphical information displayed on the touchscreen 106 based on which one of the multiple instruments 108 and 110 was utilized to provide the input to the touchscreen 106.

The graphical information may correspond to menu text and/or various buttons (e.g., a close window button, a minimize window button, and a resize window button). The graphical information may be associated with an active application window. In this case, the graphical information associated with the active application window is shrunk (when the graphical information is not already an appropriate size) when the instrument is identified as a stylus and is expanded (when the graphical information is not already an appropriate size) when the instrument is identified as a finger of a user. According to one or more aspects of the present disclosure, graphical information of other non-active applications retain a default sizing until one of the non-active applications is selected as the active application. According to this aspect, when an active application becomes inactive, the graphical information of the inactive application (formerly the active application) reverts to a default size.

The graphical information may also be associated with a desktop. In this case, the graphical information associated with the desktop is shmuk (when the graphical information is not already an appropriate size) when the instrument is identified as a stylus and is expanded (when the graphical information is not already an appropriate size) when the instrument is identified as a finger of a user. Following block 208, control transfers to block 210 where the process 200 terminates.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. For example, the present techniques can be implemented in any kind of system that includes a hard disk drive. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method, comprising:
detecting a first input to a touchscreen of a device;
determining which one of multiple instruments was utilized to provide the first input; and
sizing graphical information displayed on the touchscreen based on which one of the multiple instruments was utilized to provide the first input.

2. The method of claim 1, wherein the multiple instruments includes a stylus and a finger of a user of the device.

3. The method of claim 1, wherein the graphical information corresponds to menu text.

4. The method of claim 1, wherein the graphical information includes a close window button, a minimize window button, and a resize window button.

5. The method of claim 1, wherein the graphical information is associated with an active application window.

6. The method of claim 5, wherein the sizing further comprises:
shrinking the graphical information associated with the active application window when the instrument is identified as a stylus.

7. The method of claim 5, wherein the sizing further comprises:
enlarging the graphical information associated with the active application window when the instrument is identified as a finger of a user.

8. The method of claim 1, wherein a first instrument, included in the multiple instruments, is utilized to provide the first input and a second instrument, included in the multiple instruments, is utilized to provide a second input, and wherein the method further comprises:
resizing the graphical information displayed on the touchscreen in response to the second input, wherein the first and second instruments are different.

9. The method of claim 1, wherein the device is a tablet personal computer.

10. The method of claim 1, wherein the graphical information is associated with a desktop.

11. The method of claim 10, wherein the sizing further comprises: shrinking the graphical information associated with the desktop when the instrument is identified as a stylus.

12. The method of claim 10, wherein the sizing further comprises: enlarging the graphical information associated with the desktop when the instrument is identified as a finger of a user.

13. An apparatus, comprising:
a touchscreen; and
a processor coupled to the touchscreen, wherein the processor is configured to:
detect a first input to the touchscreen;
determine which one of multiple instruments was utilized to provide the first input; and
size graphical information displayed on the touchscreen based on which one of the multiple instruments was utilized to provide the first input.

14. The apparatus of claim 13, wherein the multiple instruments include a stylus and a finger of a user of the device.

15. The apparatus of claim 31, wherein the graphical information is selected from a group consisting of menu text, a close window button, a minimize window button, and a resize window button.

16. The apparatus of claim 13, wherein the graphical information is associated with an active application window.

17. The apparatus of claim 13, wherein the apparatus is selected from a group consisting of a tablet personal computer, a personal digital assistant, and a smart phone.

18. The apparatus of claim 13, wherein the graphical information is associated with a desktop.

19. A method, comprising:
detecting a first input to a touchscreen of a device;
determining which one of multiple instruments was utilized to provide the first input; and
displaying graphical information on the touchscreen using a first size when a first instrument, included in the multiple instruments, is determined to have been utilized to provide the first input.

20. The method of claim 19, further comprising:
displaying the graphical information on the touchscreen using a second size when a second instrument, included in the multiple instruments, is determined to have been utilized to provide a second input, wherein the first size is different than the second size.
